(19) United States
(12) Patent Application Publication
(10) Pub. No.: US 2003/0162545 A1
(43) Pub. Date: Aug. 28, 2003

(54) Overlapping coverage sectored/omni antenna architecture for dual standard support with handoff to backward-compatible standard during antenna/RF path/system failure

(75) Inventors: John S. Csapo, Dallas, TX (US); Sun Yong Park, Richardson, TX (US); Jae Doeg Lim, Allen, TX (US); Joseph Robert Cleveland, Richardson, TX (US)

Correspondence Address: Docket Clerk, P.O. Box 800889, Dallas, TX, 75380, US

(73) Assignee: SAMSUNG ELECTRONICS CO., LTD., Suwon-city (KR)

(21) Appl. No.: 10/080,889

(22) Filed: Feb. 22, 2002

(51) Int. Cl. H04Q 7/20

(52) U.S. Cl. 455/446; 455/562

(57) ABSTRACT

Two radio systems are provided for each coverage area within a wireless communications system, each radio system supporting a different wireless communications standard with at least one of the standards being compatible with the other (such as the backward-compatibility of either of 1xEV-DO or 1xEV-DV with IS-2000). Both of the radio systems may have a sectored configuration for selected coverage areas while a combination of sectored and omni configurations are employed for the radio systems for other coverage areas. When communications with a mobile station utilizing one standard fails within a coverage area due to antenna, radio frequency path, or radio system failure, wireless communications with that mobile station is automatically resumed utilizing the other, compatible wireless communications standard.

### TECHNICAL FIELD OF THE INVENTION

The present invention is directed, in general, to dual standard wireless communications systems and, more specifically, to wireless communications systems supporting dual standards inclusive in at least one direction and handoff between communication subsystems for the two standards.

### BACKGROUND OF THE INVENTION

Code division multiple access (CDMA) is increasingly being adopted by wireless communications services providers while continuing to evolve. The Telecommunications Industry Association (TIA) has published the 3^{rd} Generation (3G) IS-2000 standard (CDMA2000 1X) defining backward-compatible extension of existing CDMA communications, while proposals for CDMA2000 1x Evolution for Data Only (1xEV-DO) and CDMA2000 1x Evolution for Data & Voice (1xEV-DV) standards are currently under consideration for approval by the International Telecommunication Union (ITU).

Typical network equipment costs for building or upgrading a wireless communications system reside largely within the radio network subsystem rather than the packet and/or circuit core network subsystems. Upgrades must therefore be implemented in a cost-effective manner based upon demand for applicable services.

In addition, antenna, radio frequency (RF) path, or system failure may result in unavailability of service and/or calls being dropped, either before a connection is established or during the connection. Upgrades between compatible standards (e.g., backward-compatible standards) should therefore be implemented in the manner best exploiting potential redundancy.

There is, therefore, a need in the art for cost-effective implementation of dual or evolving standards within wireless communications systems, such as during upgrades, and for effective use of resources where dual standards are supported.

### SUMMARY OF THE INVENTION

To address the above-discussed deficiencies of the prior art, it is a primary object of the present invention to provide, for use in a wireless communications system, two radio systems for each coverage area, each radio system supporting a different wireless communications standard with at least one of the standards being compatible with the other (such as the backward-compatibility of either of 1xEV-DO or 1xEV-DV with IS-2000). Both of the radio systems may have a sectored antenna configuration for selected coverage areas, where demand for the advanced service is high, while a combination of sectored and omni configurations are employed for the radio systems for other coverage areas in which less demand for the advanced service is anticipated. In this manner, upgrades may be performed incrementally in a cost-effective manner based upon demand for the advanced services.

Within overlapping coverage areas for the two wireless communications standards, when communications with a mobile station utilizing one standard fails within a coverage area due to antenna, radio frequency path, or radio system failure, wireless communications with that mobile station are automatically resumed utilizing the other, compatible wireless communications standard. Thus, for example, when the RF path to a mobile station from a sectored antenna employed for IS-2000 communications fades or is blocked while the RF path to the mobile station from an omni antenna having overlapping coverage area but employed for 1xEV-DV communications remains clear, a call connection to the IS-2000 mobile station may be automatically established or resumed utilizing the omni antenna and backward-compatible 1xEV-DV communications.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a wireless communications system supporting dual standards and handoff between standards according to one embodiment of the present invention; and

FIGS. 2A and 2B are comparative block diagrams of radio subsystems for a wireless communications system supporting dual standards and handoff between standards according to one embodiment of the present invention;

FIGS. 3 and 3A-3B are diagrams illustrating handoff between standards within a wireless communications system supporting dual standards and handoff between standards according to one embodiment of the present invention; and

FIG. 4 is a high level flow chart for a process of handoff between standards within a wireless communications system supporting dual standards and handoff between standards according to one embodiment of the present invention.

### DETAILED DESCRIPTION OF THE INVENTION

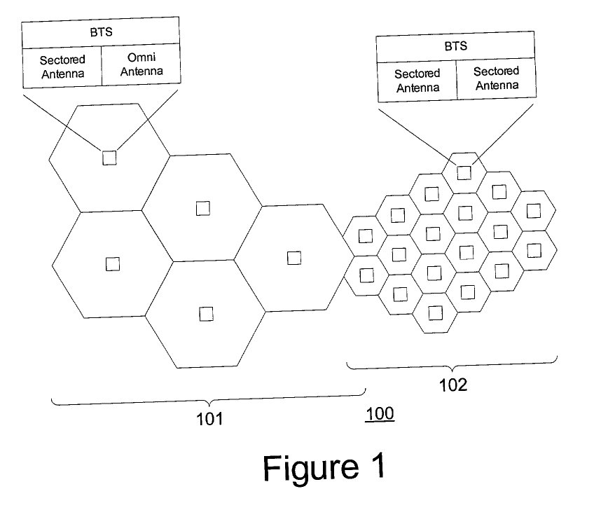

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a wireless communications system supporting dual standards and handoff between standards according to one embodiment of the present invention.

Wireless communications system 100 includes a plurality of contiguous or somewhat overlapping coverage areas or cells 101 and 102, each including at least one base transceiver station. Depending on service (capacity) requirements, larger coverage areas—and, correspondingly, smaller cell densities—may (but need not necessarily) be employed for some cells 101 than for other cells 102. For example, cells 102 may be smaller and denser than cells 101 in order to concurrently provide wireless communications service to more users with a selected quality of service (QoS).

In the present invention, each of the cells 101 and 102 provides, for mobile stations (not shown) within a respective coverage area, wireless communications with devices compliant with either of two different wireless communications standards. At least one of the two wireless communications standards is compatible with the other—that is, wireless communications utilizing the first standard allows communication with devices compliant with the second standard but not with the first standard. However, the other (or second) standard need not be compliant with the first standard, such that wireless communications utilizing the second standard will not allow communication with devices compliant with the first standard but not the second standard. Examples of such standards are 1xEV-DO and 1xEV-DV, either of which is backward-compatible with IS-2000 although IS-2000 is not forward-compatible with either of 1xEV-DO or 1xEV-DV. In an exemplary embodiment of the present invention, therefore, each of the cells 101 and 102 supports communications according, for instance, to 20 both IS-2000 and 1xEV-DO, or to both IS-2000 and 1xEV-DV.

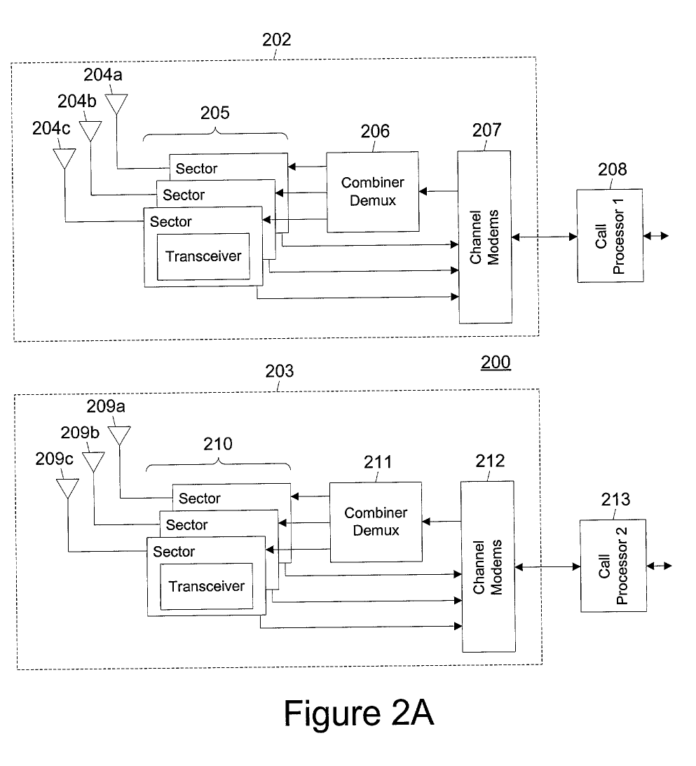

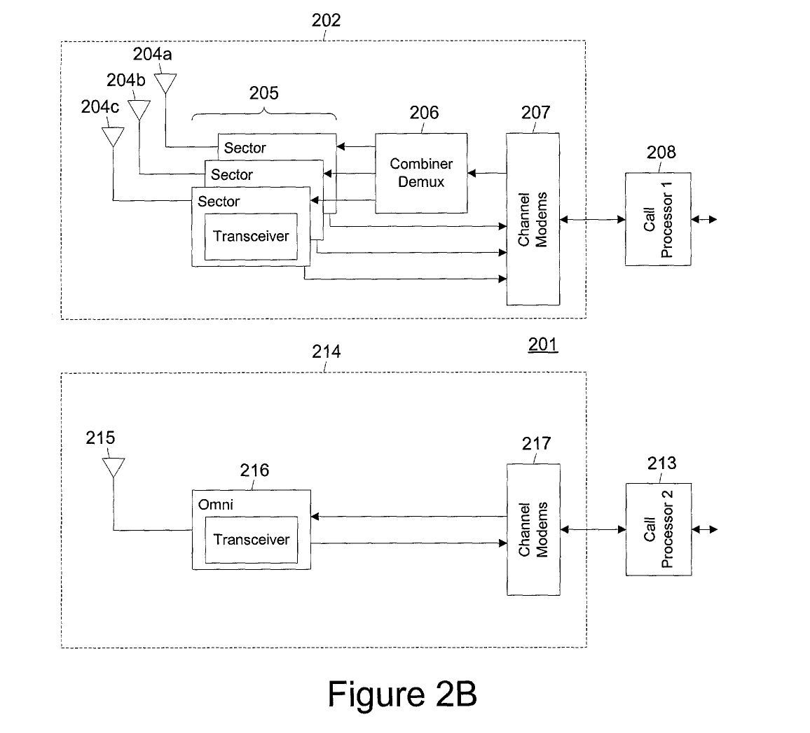

FIGS. 2A and 2B are comparative block diagrams of radio subsystems for a wireless communications system supporting dual standards and handoff between standards according to one embodiment of the present invention. Each of the cells of interest within wireless communications system 100 depicted in FIG. 1 (e.g., one of cells 101 and one of cells 102) includes either radio subsystem 200 as depicted in FIG. 2A or radio subsystem 201 as depicted in FIG. 2B.

Those skilled in the art will recognize that the complete construction and operation of a base transceiver station is not depicted or described. Instead, for simplicity and clarity, only so much of the construction and operation of a base transceiver station, and of a wireless communications system in general, as is unique to the present invention or necessary for an understanding of the present invention is depicted in the drawings and described herein.

Radio subsystem 200 provides dual standard or system operation for a base transceiver station (BTS) within the respective cell, and includes sectored antenna configurations 202 and 203. Antenna subsystem 202 includes directional antennas 204a-204c for the three sector configuration of the exemplary embodiment, each having a maximum beam width of 120 degrees and coupled to a different one of sector transceiver subsystems 205. Sector transceiver subsystems 205 receive signals to be transmitted through combiner/demultiplexer 206 from channel modems 207, and pass received signals to channel modems 207. Channel modems 207 are coupled to a first call processor 208 for the base transceiver station within the respective cell.

Antenna subsystem 203 includes directional antennas 209a-209c for each of the three sectors, each coupled to a different one of sector transceiver subsystems 210 which receive signals to be transmitted through combiner/demultiplexer 211 from channel modems 212 and pass received signals to channel modems 212, with channel modems 212 being coupled to a second call processor 213 for the base transceiver station within the respective cell. Radio subsystem 201 also provides dual standard or system operation for the base transceiver station within the respective cell, but includes only one sectored antenna subsystem 202 coupled to the first call processor 208.

However the other antenna subsystem 214, coupled to the second call processor 213, is an omni configuration having a single antenna 215 with 360 degree coverage coupled via transceiver subsystem 215 to channel modems 217.

In the present invention, selected cells within the wireless communications system 100 are equipped with radio subsystem 200, while other cells are equipped with radio subsystem 201. Thus, for example, if cells 102 have or require a high capacity, for concurrently providing service to a large number of users (e.g., located within a densely populated or heavily traveled geographic region), those cells 102 may be equipped with radio subsystem 200 having two sectored antennas 202 and 203. If cells 101 have or require a lower capacity for concurrently providing service to a smaller number of users (e.g., located in a rural or infrequently traveled geographic region), those cells 101 are equipped instead with radio subsystem 201 having one sectored antenna 202 and one omni antenna 214. In this manner, the expense of equipping wireless communications system 100 with the requisite radio infrastructure to support both wireless communications standards may be minimized, or at least reduced over use of dual sectored antenna configurations for all coverage areas.

Each cell of interest within wireless communications system 100 includes one of radio subsystems 200 or 201, with each antenna subsystem 202 and 203 or 214 supporting a different one of the two wireless communications standards employed by wireless communications system 100. Thus, for instance, when radio subsystem 201 is employed for a coverage area, sectored antenna subsystem 202 may support IS-2000 communications while omni antenna subsystem 214 supports either 1xEV-DO or 1xEV-DV communications as desired. In this manner, upgrades to wireless communications system (i.e., from supporting only IS-2000 communications to supporting both IS-2000 and either 1xEV-DO or 1xEV-DV communications) may be performed in a cost effective manner. Alternatively, radio subsystem 201 may be employed with sectored antenna subsystem 202 supporting either 1xEV-DO or 1xEV-DV communications as desired while omni antenna subsystem 214 supports IS-2000 data and voice communications within, e.g., a new base transmitter station for the wireless communications system 100.

Regardless of whether sectored/sectored antennae configuration 200 or sectored/omni antennae configuration 201 is employed, service for one communications standard operates on one frequency assignment (FA1) while service for the other communications standard operates on a second, different frequency assignment (FA2). Thus, for example, IS-2000 data and voice communications may be provided through sectored antenna subsystem 202 using the first frequency FA1 while either 1xEV-DO or 1xEV-DV communications, as desired, is provided through omni antenna subsystem 214 using the second frequency FA2.

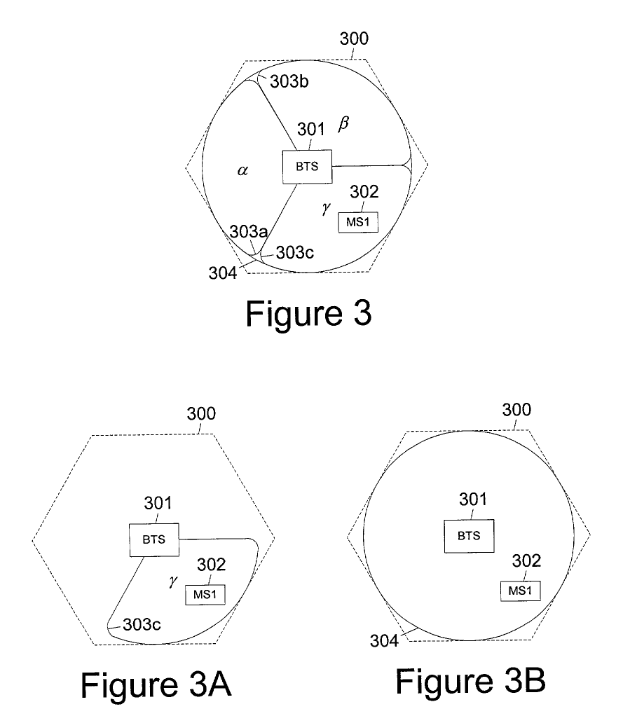

FIGS. 3 and 3A-3B are diagrams illustrating handoff between standards within a wireless communications system supporting dual standards and handoff between standards according to one embodiment of the present invention.

FIG. 3 depicts a single wireless communications coverage area or cell 300, which is one of the cells 101 and 102 depicted in FIG. 1 in which one the radio subsystems 200-201 depicted in FIGS. 2A-2B is deployed. In the particular example shown, the radio subsystem 201 depicted in FIG. 2B is implemented within cell 300, with the sectored antenna subsystem 202 employed for IS-2000 communications and the omni antenna subsystem 214 employed for, for instance, 1xEV-DV communications.

As noted above, wireless communications system 100 supports two different wireless communications standards, one of which is compatible (or “inclusive”) of the other. To support, for instance, both IS-2000 and 1xEV-DV, two independent sets of channel modems are required, one set 207 for IS-2000 communications and one set 217 for 1xEV-DV communications (assuming the sectored antenna 202 within radio subsystem 201 supports IS-2000 while the omni antenna 214 supports 1xEV-DV as described above). Similarly two call processors 208 and 213 are required, one for IS-2000 communications and one for 1xEV-DV communications. Thus, coverage area 300 contains a base transceiver station 301 including radio subsystem 201 providing IS-2000 communications with one mobile station (MS1) 302 within one sector γ of the three sectors α, β, γ (303a-303c, respectively) each served by one of the directional antennae 204a-204c and associated sector transceiver 201 within antenna subsystem 202.

In normal operation, both systems 202 and 214 provide voice and data calls with the respective call signaling and processing for the supported standard. The 1xEV-DV call processor 217 provides cold-standby redundancy for the IS-2000 call processor 208 in case of IS-2000 call processor failure, or failure of either the associated antenna subsystem 202 or the RF path to the mobile station (e.g., due to fading). Thus, when the IS-2000 call processor 208 suddenly detects an antenna or RF path failure within sector γ while providing communications to mobile station 302 (as shown in FIG. 3A) for, for instance, a voice call, with antenna subsystem 202 unable to provide communications within the shadowed area into which mobile station 302 has moved, the cold-standby 1xEV-DV call processor 213 and associated omni antenna having overlapping coverage area 304 takes over all operations for the call (as shown in FIG. 3B) from the IS-2000 call processor 208 with an allowed, minimal delay.

In case of an IS-2000 call processor 208 failure, the voice call being provided is terminated and the handoff proceeds as follows:

1) The IS-2000 call processor 208 sends all of the call information to the 1xEV-DV call processor 213 via an internal link between the two call processors.

2) A handoff request is sent from the IS-2000 call processor 208 to the 1xEV-DV call processor 213 for channel configuration and maintenance control.

3) The 1xEV-DV call processor 213 continues IS-2000 voice traffic to the mobile station 302 and provides IS-2000 voice/data services to other mobile stations within the failed sector. All registration/origination/page information for IS-2000 voice/data calls with the mobile station 302 is routed to the 1xEV-DV call processor 213, and the mobile switching center (MSC) or other controller follows the same IS-2000 call flow while routing IS-2000 calls for the sector through the 1xEV-DV call processor 213.

4) The 1xEV-DV call processor 213 simultaneously supports 1xEV-DV voice/data calls using an intelligent scheduling algorithm based on quality of service.

5) Upon completion of the IS-2000 maintenance and repairs, the IS-2000 calls are terminated by the 1xEV-DV call processor 213 and provision of only 1xEV-DV services by that call processor is resumed.

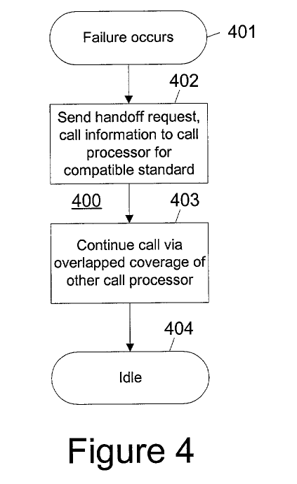

FIG. 4 is a high level flow chart for a process of handoff between standards within a wireless communications system supporting dual standards and handoff between standards according to one embodiment of the present invention. The process 400 is implemented within the wireless communications system depicted in FIGS. 1-3, and begins with failure of an antenna, RF path, or communications system (step 401) during a call. The call processor for the interrupted call transmits a handoff request and call information to a second call processor serving an overlapping coverage area utilizing a compatible standard (step 402). The second call processor then continues the call (step 403) and the process becomes idle (step 404) until a subsequent failure occurs.

The present invention provides handoff from IS-2000 to 1xEV-DV systems during IS-2000 antenna or RF path failure, guaranteeing effective handoffs with the allowed minimal time delay and minimal cost impact to existing base transceiver stations.

In the exemplary embodiment above, the IS-2000 and 1xEV-DV systems are co-located. However, the same handoff is possible with remote location of the two systems without performance impact, with internal links between the two systems. Thus, for example, the handoff may be performed between adjoining coverage areas when mobile station is located within a soft handoff region common to the two coverage areas.

The implementation of handoff between standards provides true backward compatibility from 1xEV-DV systems to IS-2000 systems, including the worst-case situation of failure. Moreover, the same arrangement may be employed for backward compatibility between 1xEV-DO and IS-2000 or 1xEV-DV and 1xEV-DO for data calls.

In addition, the present invention provides cost effective implementation of dual standards within a wireless communications network, including upgrades to existing facilities. Use of an omni antenna for one standard and sectored antennae for another standard, where one standard is compatible or inclusive of the other, provides efficient redundancy as well as backward compatibility.

It is important to note that while the present invention has been described in the context of a fully functional communications device or system, those skilled in the art will appreciate that the mechanism of the present invention is capable of being implemented and distributed in the form of a computer usable medium of instructions in a variety of forms, and that the present invention applies equally regardless of the particular type of signal bearing medium is used to carry out the distribution. Examples of suitable computer usable mediums include: nonvolatile, hard-coded or programmable type mediums such as read only memories (ROMs) or erasable, electrically programmable read only memories (EEPROMs), recordable type mediums such as floppy disks, hard disk drives, and read/write (R/W) compact disc read only memories (CD-ROMs) or digital versatile discs (DVDs), and transmission type mediums such as digital and analog communications links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. For use in a wireless communications system, an apparatus for supporting dual standards comprising:
a sectored antenna system for a coverage area; and
an omni antenna system for the coverage area, wherein the sectored antenna system is employed for wireless communications utilizing a first standard within the coverage area and the omni antenna system is employed for wireless communications utilizing a second standard within the coverage area.

2. The apparatus according to claim 1, wherein one of the first and second standards is compatible with the other of the first and second standards.

3. The apparatus according to claim 2, wherein, upon failure of wireless communications utilizing the other of the first and second standards within the coverage area, wireless communications utilizing the other of the first and second standards within the coverage area is resumed with the antenna system employed for the compatible one of the first and second standards.

4. The apparatus according to claim 1, wherein the first standard is IS-2000 and the second standard is one of 1xEV-DO and 1xEV-DV.

5. The apparatus according to claim 1, wherein the first standard is one of 1xEV-DO and 1xEV-DV and the second standard is IS-2000.

6. For use in a wireless communications system, an apparatus for supporting dual standards comprising:
a first coverage area employing a sectored antenna system for wireless communications utilizing a first standard within the first coverage area and a sectored antenna system for wireless communications utilizing a second standard within the first coverage area; and
a second coverage area employing a sectored antenna system for wireless communications utilizing the first standard within the second coverage area and an omni antenna system for wireless communications utilizing the second standard within the second coverage area.

7. The apparatus according to claim 6, wherein one of the first and second standards is compatible with the other of the first and second standards.

8. The apparatus according to claim 7, wherein, upon failure of wireless communications utilizing the other of the first and second standards within one of the first and second coverage areas, wireless communications utilizing the other of the first and second standards within the one of the first and second coverage areas is resumed with the antenna system employed for the compatible one of the first and second standards.

9. The apparatus according to claim 6, wherein the first standard is IS-2000 and the second standard is one of 1xEV-DO and 1xEV-DV.

10. The apparatus according to claim 6, wherein the first standard is one of 1xEV-DO and 1xEV-DV and the second standard is IS-2000.

11. For use in a wireless communications system, an apparatus for supporting dual standards comprising:
a first antenna system for wireless communications utilizing a first standard within a coverage area; and
a second antenna system for wireless communications utilizing a second standard within the coverage area,
wherein one of the first and second standards is compatible with the other of the first and second standards and, upon failure of wireless communications utilizing the other of the first and second standards within the coverage area, wireless communications utilizing the other of the first and second standards within the coverage area is resumed with the antenna system employed for the compatible one of the first and second standards.

12. The apparatus according to claim 11, wherein the first antenna system is a sectored system and the second antenna system is an omni system.

13. The apparatus according to claim 11, wherein the first antenna system is an omni system and the second antenna system is a sectored system.

14. The apparatus according to claim 11, wherein the first standard is IS-2000 and the second standard is one of 1xEV-DO and 1xEV-DV.

15. The apparatus according to claim 11, wherein the first standard is one of 1xEV-DO and 1xEV-DV and the second standard is IS-2000.

16. For use in a wireless communications system, a method of supporting dual standards comprising:
employing a sectored antenna system for wireless communications utilizing a first standard within a coverage area; and
employing an omni antenna system for the coverage area, wherein the sectored antenna system is employed for wireless communications utilizing a second standard within the coverage area.

17. The method according to claim 16, wherein one of the first and second standards is compatible with the other of the first and second standards.

18. The method according to claim 17, further comprising:
upon failure of wireless communications utilizing the other of the first and second standards within the coverage area, resuming wireless communications utilizing the other of the first and second standards within the coverage area with the antenna system employed for the compatible one of the first and second standards.

19. The method according to claim 16, wherein the first standard is IS-2000 and the second standard is one of 1xEV-DO and 1xEV-DV.

20. The method according to claim 16, wherein the first standard is one of 1xEV-DO and 1xEV-DV and the second standard is IS-2000.

21. For use in a wireless communications system, a method of supporting dual standards comprising:
employing a sectored antenna system for wireless communications utilizing a first standard within a first coverage area and a sectored antenna system for wireless communications utilizing a second standard within the first coverage area; and
employing a sectored antenna system for wireless communications utilizing the first standard within a second coverage area and an omni antenna system for wireless communications utilizing the second standard within the second coverage area.

22. The method according to claim 21, wherein one of the first and second standards is compatible with the other of the first and second standards.

23. The apparatus according to claim 22, further comprising:
upon failure of wireless communications utilizing the other of the first and second standards within one of the first and second coverage areas, resuming wireless communications utilizing the other of the first and second standards within the one of the first and second coverage areas with the antenna system employed for the compatible one of the first and second standards.

24. The method according to claim 21, wherein the first standard is IS-2000 and the second standard is one of 1xEV-DO and 1xEV-DV.

25. The method according to claim 21, wherein the first standard is one of 1xEV-DO and 1xEV-DV and the second standard is IS-2000.

26. For use in a wireless communications system, a method of supporting dual standards comprising:
employing a first antenna system for wireless communications utilizing a first standard within a coverage area;
employing a second antenna system for wireless communications utilizing a second standard within the coverage area, wherein one of the first and second standards is compatible with the other of the first and second standards; and
upon failure of wireless communications utilizing the other of the first and second standards within the coverage area, resuming wireless communications utilizing the other of the first and second standards within the coverage area with the antenna system employed for the compatible one of the first and second standards.

27. The method according to claim 26, wherein the first antenna system is a sectored system and the second antenna system is an omni system.

28. The method according to claim 26, wherein the first antenna system is an omni system and the second antenna system is a sectored system.

29. The method according to claim 26, wherein the first standard is IS-2000 and the second standard is one of 1xEV-DO and 1xEV-DV.

30. The method according to claim 26, wherein the first standard is one of 1xEV-DO and 1xEV-DV and the second standard is IS-2000.
